(19) United States
(12) Patent Application Publication
(10) Pub. No.: US 2011/0061480 A1
(43) Pub. Date: Mar. 17, 2011

(54) QUICK-RELEASE MECHANISM OF AN ACTUATOR

(76) Inventors: Kuo-En TSENG, Taichung City (TW); Hsin-An Chiang, Taichung City (TW)

(21) Appl. No.: 12/558,690

(22) Filed: Sep. 14, 2009

(30) Foreign Application Priority Data
Sep. 11, 2009 (TW) 098126877

(51) Int. Cl. F16D 11/10; F16H 25/20

(52) U.S. Cl. 74/89.14; 192/69.8

(57) ABSTRACT

A quick-release mechanism of an actuator, including: a worm wheel having a circular body section, a shaft hole extending through the body section along a curvature center line thereof; a rod-like push body coaxially fitted through the shaft hole; and a clutch unit having a first clutch section and a second clutch section. The first clutch section is integrally formed on an end face of the body section. The second clutch section is slidably and relatively unrotatably fitted on the push body. The second clutch section is movable along an axis of the push body between a disengaging position and an engaging position. When positioned in the engaging position, the first and second clutch sections are engaged to drivingly couple the push body with the worm wheel. When positioned in the disengaging position, the first and second clutch sections are disengaged to uncouple the push body from the worm wheel.

### BACKGROUND OF THE INVENTION

The present invention relates generally to an actuator, and more particularly to a quick-release mechanism of an actuator.

In the field of electromechanics, various actuators, which can convert electrical energy into mechanical energy, are widely used to supply power as drive units. A conventional linear actuator has the advantages of light weight, compact structure, convenient operation, easy installation, low noise, high rigidity and low price. Therefore, all kinds of linear actuators have been popularly applied to different products such as automated equipments, motor-driven hospital beds and massage chairs. The actuators serve to stably output power for driving the products and are able to enhance precision of the automated equipments.

The conventional actuator is generally equipped with a quick-release mechanism. As an example, in normal state, a motor-driven hospital bed is drivable by the actuator to adjust the angle and height of the bed face. The hospital bed must be driven at slow speed. Otherwise, a patient may be negatively affected. However, in case that an emergency takes place and the patient on the hospital bed must be emergently treated, it will be necessary to quickly restore the hospital bed to a horizontal position at a lower height to facilitate the emergency treatment. At this time, the transmission path of the conventional actuator must be interrupted, permitting the hospital bed to be more quickly restored to its home position. FIG. 1 shows the clutch mechanism 1 of the conventional actuator for interrupting the transmission path.

The clutch mechanism 1 substantially includes a worm wheel 2 drivable by a motor to rotate. One end of a transmission sleeve 3 is coaxially fixedly fitted in the worm wheel 2, whereby the transmission sleeve 3 is movable along with the worm wheel 2. A clutch collar 4 is fitted on the other end of the transmission sleeve 3 and slidable along the axis thereof. A push shaft 5 is freely rotatably coaxially fitted through the worm wheel 2, the transmission sleeve 3 and the clutch collar 4. A clutch tray 6 is coaxially fixedly fitted on the push shaft 5 to engage with or disengage from the clutch collar 4. A spring 7 is compressed between the clutch collar 4 and the worm wheel 2 for resiliently pushing the clutch collar 4 to engage with the clutch tray 6. Accordingly, when the worm wheel 2 is driven by the motor to rotate, through the transmission sleeve 3, the clutch collar 4 and the clutch tray 6, the push shaft 5 is simultaneously driven and rotated to output power. When it is necessary to quickly release the push shaft 5, the clutch collar 4 is pushed to disengage from the clutch tray 6 for quickly releasing the push shaft 5.

However, the above clutch mechanism 1 has some defects. For example, the clutch mechanism 1 is composed of numerous components so that the structure of the clutch mechanism 1 is complicated. As a result, the clutch mechanism 1 has a considerably large volume and is manufactured at higher cost. Moreover, the clutch mechanism 1 is composed of so many components that the possibility of failure of the clutch mechanism 1 is increased.

### SUMMARY OF THE INVENTION

It is therefore a primary object of the present invention to provide a quick-release mechanism of an actuator, which has smaller number of components and is manufactured by simplified process at lower cost.

It is a further object of the present invention to provide the above quick-release mechanism of the actuator, which has smaller volume and shortened power transmission distance.

To achieve the above and other objects, the quick-release mechanism of the actuator of the present invention includes: a worm wheel having a circular body section, a shaft hole extending through the body section along a curvature center line thereof; a rod-like push body coaxially fitted through the shaft hole; and a clutch unit having a first clutch section and a second clutch section, the first clutch section being connected with the worm wheel, the second clutch section being connected with the push body, the first and second clutch sections being movable relative to each other between a disengaging position and an engaging position, when positioned in the engaging position, the first and second clutch sections being engaged with each other to drivingly couple the worm wheel with the push body, when positioned in the disengaging position, the first and second clutch sections being disengaged from each other to uncouple the worm wheel from the push body, the clutch unit further having a resilient member, which provides resilient force for making the first and second clutch sections engaged with each other, said quick-release mechanism being characterized in that: the first clutch section is integrally formed at one end of the body section; the second clutch section is relatively unrotatably fitted on the push body and slidable along an axis of the push body between the disengaging position and the engaging position, whereby when positioned in the engaging position, a first end of the second clutch section is engaged with the first clutch section; and the clutch unit further includes a stopper member fixedly disposed on the push body and adjacent to a second end of the second clutch section, the resilient member being compressed between the stopper member and the second clutch section.

The present invention can be best understood through the following description and accompanying drawings wherein:

### BRIEF DESCRIPTION OF THE DRAWINGS

FIG. 1 is a perspective exploded view of a conventional clutch mechanism;

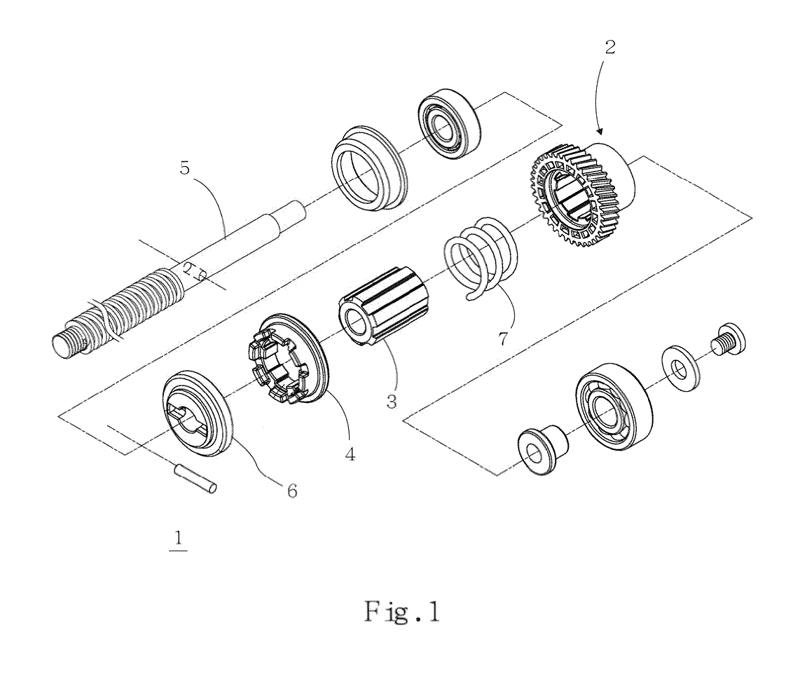

FIG. 2 is a perspective view of a preferred embodiment of the present invention;

FIG. 3 is a perspective exploded view of the preferred embodiment of the present invention;

FIG. 4 is a perspective assembled view of the preferred embodiment of the present invention;

FIG. 5 is a sectional view of the preferred embodiment of the present invention, in which the clutch unit is positioned in the engaging position;

FIG. 6 is a perspective view of the preferred embodiment of the present invention, in which the clutch unit is positioned in the engaging position;

FIG. 7 is a sectional view of the preferred embodiment of the present invention, in which the clutch unit is positioned in the disengaging position; and

FIG. 8 is a perspective view of the preferred embodiment of the present invention, in which the clutch unit is positioned in the disengaging position.

### DETAILED DESCRIPTION OF THE PREFERRED EMBODIMENT

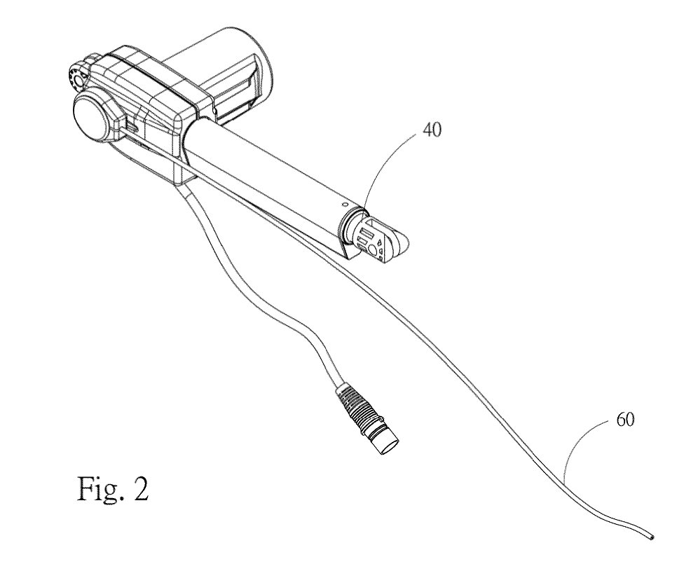

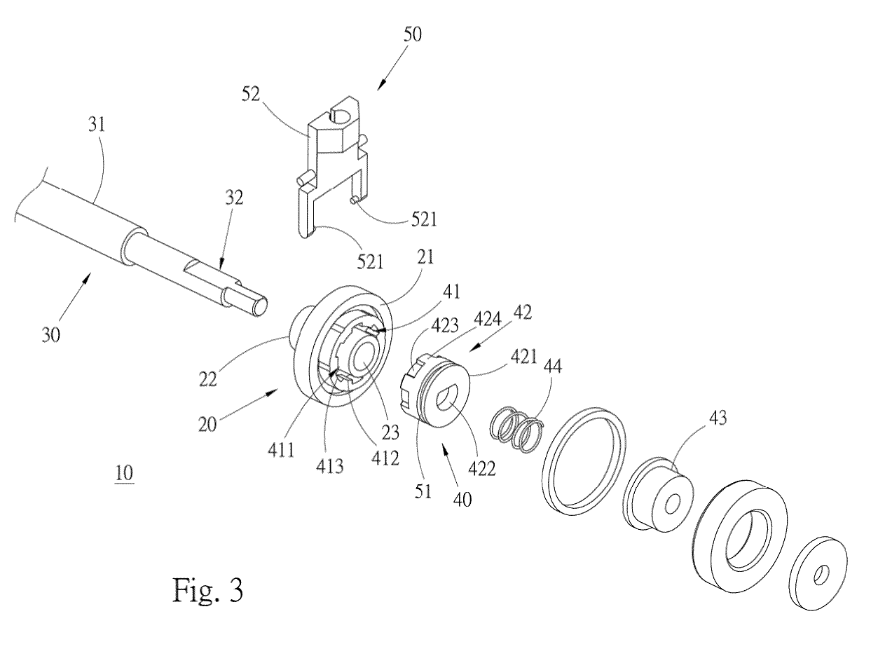

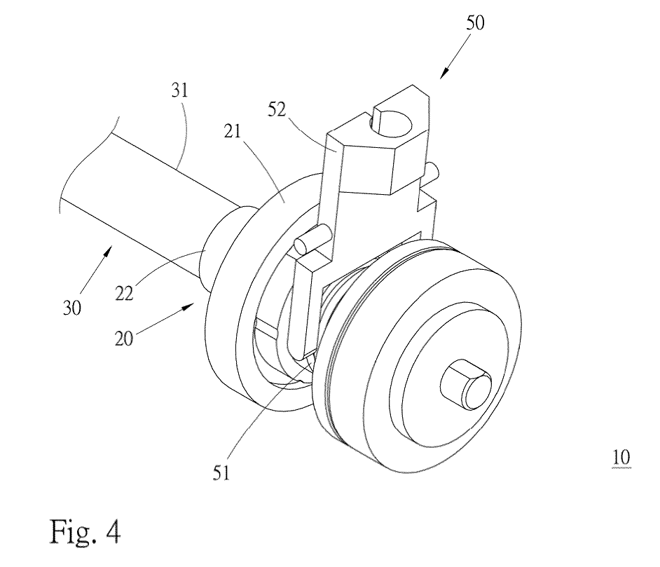

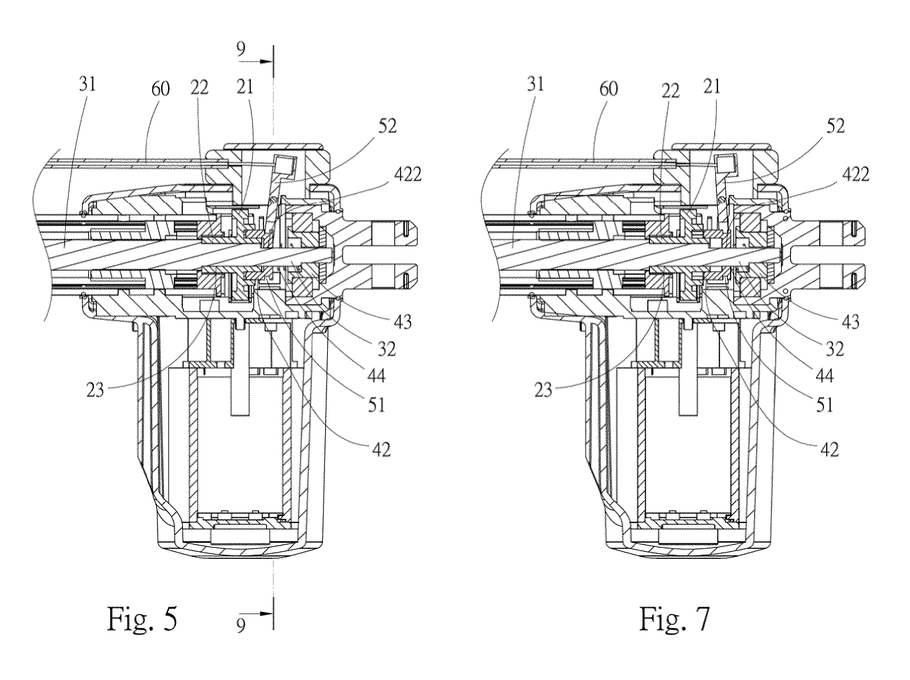

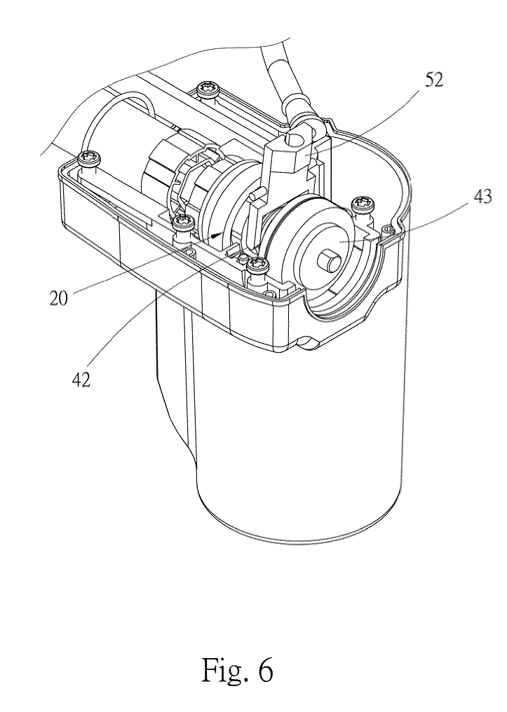

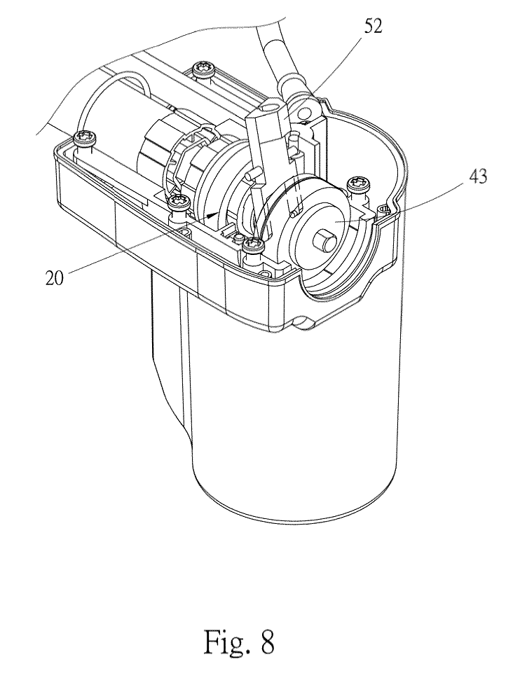

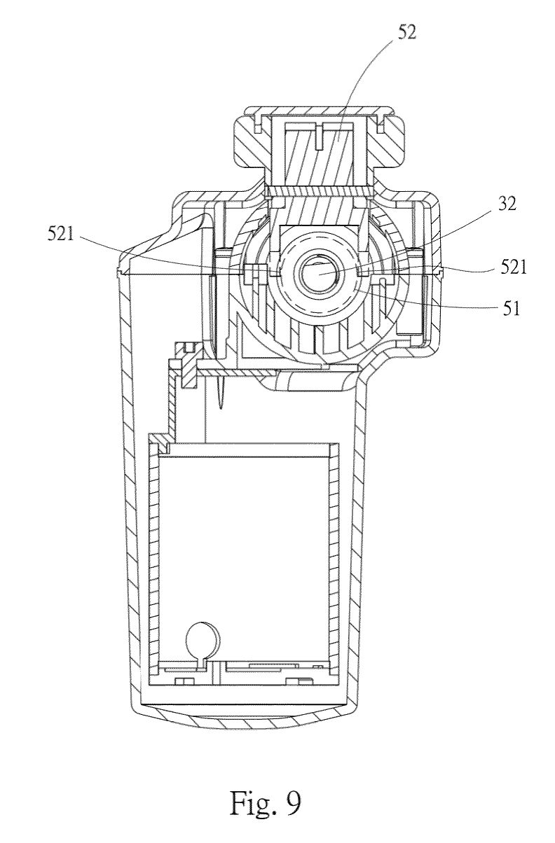

Please refer to FIGS. 2 to 9. According to a preferred embodiment, the quick-release mechanism 10 of the actuator of the present invention includes a worm wheel 20, a push body 30, a clutch unit 40 and a shift section 50.

The worm wheel 20 has a circular body section 21 and a shaft sleeve 22 integrally formed in the body section 21 at a curvature center thereof.

The shaft sleeve 22 has a length larger than a thickness of the body section 21. Two ends of the shaft sleeve 22 axially protrude from two ends of the body section 21. The shaft sleeve 22 has a shaft hole 23 extending through the shaft sleeve 22 along a curvature center line of the body section 21.

The push body 30 is rod-like and has a rod section 31 coaxially fitted through the shaft hole 23 and freely rotatable within the shaft hole 23. The push body 30 further has a D-shaped cut section 32 one end of which is coaxially connected with one end of the rod section 31.

The clutch unit 40 includes a first annular clutch section 41 coaxially formed on an end face of the body section 21 and a second clutch section 42 having the form of an annular block. The second clutch section 42 is coaxially slidably fitted on the D-shaped cut section 32 of the push body 30. A first end of the second clutch section 42 complementarily faces the first clutch section 41. A stopper member 43 is fixedly disposed at the other end of the D-shaped cut section 32. A resilient member 44 is compressed between the stopper member 43 and a second end of the second clutch section 42. The resilient member 44 always exerts a resilient force onto the second clutch section 42 in a direction to the first clutch section 41 to make the first end of the second clutch section 42 engaged with the first clutch section 41.

To speak more specifically, the first clutch section 41 has an annular recess 411 formed on the end face of the body section 21. The curvature center line of the annular recess 411 coincides with the curvature center line of the body section 21. Multiple keys 412 and key slots 413 are alternately integrally formed on outer circumferential wall of the annular recess 411 in parallel to each other.

The second clutch section 42 has a main body 421 as a circular block. A D-shaped through hole 422 is formed through the main body 421 along an axis thereof, in which the D-shaped cut section 32 is fitted. Accordingly, the second clutch section 42 is rotatable along with the push body 30 and reciprocally slidable along the axis of the push body 30 between a disengaging position and an engaging position. Multiple key slots 423 and keys 424 are alternately formed on outer circumference of the first end of the main body 421 in parallel to each other. Accordingly, when the second clutch section 42 is positioned in the engaging position, the first end of the main body 421 extends into the annular recess 411. Under such circumstance, the key slots 423 and keys 424 of the second clutch section and the keys 412 and key slots 413 of the first clutch section are complementarily inserted in and engaged with each other. In this case, the first and second clutch sections 41, 42 are engaged and coupled with each other. When the second clutch section 42 is positioned in the disengaging position, the main body 421 of the second clutch section 42 is moved out of the annular recess 411. Under such circumstance, the first and second clutch sections 41, 42 are disengaged and uncoupled from each other. At this time, the first and second clutch sections 41, 42 are independently from each other without drivingly engaged with each other.

The resilient member 44 is a compression spring fitted on the D-shaped cut section 32 of the push body 30. Two ends of the resilient member 44 respectively abut against the end face of the second end of the main body 421 and the stopper member 43. The resilient member 44 always exerts a resilient force onto the second clutch section 42 in a direction to the first clutch section 41 to make the main body 421 engaged in the annular recess 411.

The shift section 50 includes an annular hook groove 51 formed on the circumference of the main body 421 and a shift body 52 having two arms extending from one end of the shift body 52 in a U-shaped configuration. A middle section of the shift body 52 is pivotally connected to a housing of the actuator, whereby the shift body 52 can be pivotally rotated. Free ends of the two arms of the shift body 52 are formed with oppositely extending hooks 521. The hooks 521 are inlaid in the hook groove 51, whereby when rotating the shift body 52, the main body 421 is driven to move the second clutch section 42 from the engaging position to the disengaging position.

According to the above arrangement, in use of the quick-release mechanism 10, a user only needs to pull an outward extending pull cord 60 to rotate the shift body 52 and shift the second clutch section 42 to the disengaging position. In this case, the worm wheel 20 is uncoupled from the push body 30, permitting the push body 30 to be independently rotated and quickly restored to its home position. In comparison with the prior art, in addition to the convenient release, the quick-release mechanism 10 of the actuator of the present invention further has the following advantages:
1. The first clutch section 42 of the clutch unit 30 of the quick-release mechanism 10 is not an independent component as in the prior art. Instead, the first clutch section 42 is integrally formed on the given worm wheel of the actuator. Accordingly, the clutch unit 30 has smaller number of components to achieve the same clutch effect as the prior art. Therefore, the quick-release mechanism 10 can be manufactured by simplified process at lower cost.
2. The first clutch section 42 is integrally formed on the worm wheel 20 of the actuator. Therefore, it is unnecessary to reserve an additional axial space on one side of the worm wheel 20 for accommodating the independent clutch component as in the prior art. Accordingly, the volume of the actuator is reduced as a whole. Moreover, the power transmission distance between the worm wheel 20 and the push body 30 is shortened, whereby the actuator can more precisely drive the push body.

The above embodiment is only used to illustrate the present invention, not intended to limit the scope thereof. Many modifications of the above embodiment can be made without departing from the spirit of the present invention.

What is claimed is:

1. A quick-release mechanism of an actuator, comprising:
a worm wheel having a circular body section, a shaft hole extending through the body section along a curvature center line thereof;
a rod-like push body coaxially fitted through the shaft hole; and
a clutch unit having a first clutch section and a second clutch section, the first clutch section being connected with the worm wheel, the second clutch section being connected with the push body, the first and second clutch sections being movable relative to each other between a disengaging position and an engaging position, when positioned in the engaging position, the first and second clutch sections being engaged with each other to drivingly couple the worm wheel with the push body, when positioned in the disengaging position, the first and second clutch sections being disengaged from each other to uncouple the worm wheel from the push body, the clutch unit further having a resilient member, which provides resilient force for making the first and second clutch sections engaged with each other, said quick-release mechanism being characterized in that:
the first clutch section is integrally formed at one end of the body section;
the second clutch section is relatively unrotatably fitted on the push body and slidable along an axis of the push body between the disengaging position and the engaging position, whereby when positioned in the engaging position, a first end of the second clutch section is engaged with the first clutch section; and
the clutch unit further includes a stopper member fixedly disposed on the push body and adjacent to a second end of the second clutch section, the resilient member being compressed between the stopper member and the second clutch section.

2. The quick-release mechanism of the actuator as claimed in claim 1, wherein the first clutch section has an annular recess coaxially formed on an end face of the end of the body section, multiple spline keys and key slots being alternately disposed on a circumferential wall of the annular recess in parallel to each other, the second clutch section having a main body slidable fitted on the push body, multiple key slots and spline keys being alternately disposed on a circumference of the first end of the main body in parallel to each other, when the second clutch section is positioned in the engaging position, the key slots and keys of the second clutch section and the keys and key slots of the first clutch section being complementarily inserted in and engaged with each other, whereby the first and second clutch sections are engaged and coupled with each other and synchronously rotatable.

3. The quick-release mechanism of the actuator as claimed in claim 2, wherein a D-shaped through hole is formed through the main body of the second clutch section along an axis thereof, the push body having a D-shaped cut section complementary to the D-shaped through hole of the second clutch section, whereby the D-shaped cut section is fitted in the D-shaped through hole.

4. The quick-release mechanism of the actuator as claimed in claim 2, further comprising a shift section having an annular hook groove formed on the circumference of the main body, the annular hook groove having a curvature center line coinciding with the axis of the push body, the shift section further having a shift body, one end of the shift body being inlaid in the hook groove, whereby when rotating the shift body, the main body is driven to move the second clutch section from the engaging position to the disengaging position.
